(19) United States
(12) Patent Application Publication
(10) Pub. No.: US 2006/0145701 A1
(43) Pub. Date: Jul. 6, 2006

(54) Method and apparatus for testing and calibrating a small-signal electronic battery tester

(76) Inventor: Matt Koran, Medina, OH (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/024,451

(22) Filed: Dec. 30, 2004

(51) Int. Cl. G01N 27/416

(52) U.S. Cl. 324/426

(57) ABSTRACT

Exemplary methodologies and apparatuses for testing and calibrating small-signal battery testers are provided. An exemplary apparatus includes one or more capacitors electrically coupled to one or more conductive elements, and a power supply. The one or more conductive elements include one or more connection points for connecting the small-signal battery tester. The one or more connection points are arranged to arrange the selection of one or more impedance, conductance, resistance or admittance values that can be used to test or calibrate or test a small-signal battery tester.

### BACKGROUND

Small-signal electronic battery testers are used to determine various parameters of storage batteries, such as state of charge, battery condition, battery capacity, and the existence of defects in the battery. A common small-signal electronic battery tester functions by connecting a first test lead to the positive terminal of a battery and a second test lead to the negative terminal of the battery. The small-signal battery tester applies a relatively small alternating current to the battery and measures a battery parameter, such as, for example resistance, impedance, admittance, or conductance. The condition of the battery is determined as a function of, among other things, one or more of these parameters.

Battery testers are tested and/or calibrated to ensure that a battery tester is providing accurate output data. Typically, the battery tester is calibrated by testing a test battery that has known electrical parameters, with which the output data of the battery tester may be compared. However, the tendency for inactive chemical storage batteries to degrade over time can cause the electrical parameters of the test battery to deviate from the known electrical parameters, resulting in improper testing or calibrating of the battery tester.

### SUMMARY

Exemplary methodologies and apparatuses for testing and calibrating small-signal battery testers are provided. An exemplary apparatus includes one or more capacitors electrically coupled to one or more conductive elements, and a power supply. The one or more conductive elements include one or more connection points for connecting the small-signal battery tester. The one or more connection points are arranged to arrange the selection of one or more impedance, conductance, resistance or admittance values that can be used to test or calibrate or test a small-signal battery tester.

### BRIEF DESCRIPTION OF THE DRAWINGS

In the accompanying drawings, which are incorporated in and constitute a part of this specification, embodiments of the invention are illustrated, which, together with a general description of the invention given above, and the detailed description given below, serve to example principles of this invention, wherein:

FIG. 1A is a high level schematic block diagram of an exemplary embodiment of a small-signal battery tester connected to a battery test and/or calibration circuit;

FIG. 1B is a high level schematic block diagram of another exemplary embodiment of a small-signal battery tester connected to a battery test and/or calibration circuit;

FIG. 2 is a prospective view of an exemplary embodiment of a test and/or calibration circuit having one pair of small-signal battery tester test connection points;

FIG. 3 is a prospective view of an exemplary embodiment of a test and/or calibration circuit having a plurality of small-signal battery tester test connection points;

FIG. 4 illustrates an exemplary methodology for testing and/or calibrating a small-signal battery tester; and

FIGS. 5, 5A and 5B illustrate another exemplary methodology for testing and/or calibrating a small-signal battery tester.

### DESCRIPTION

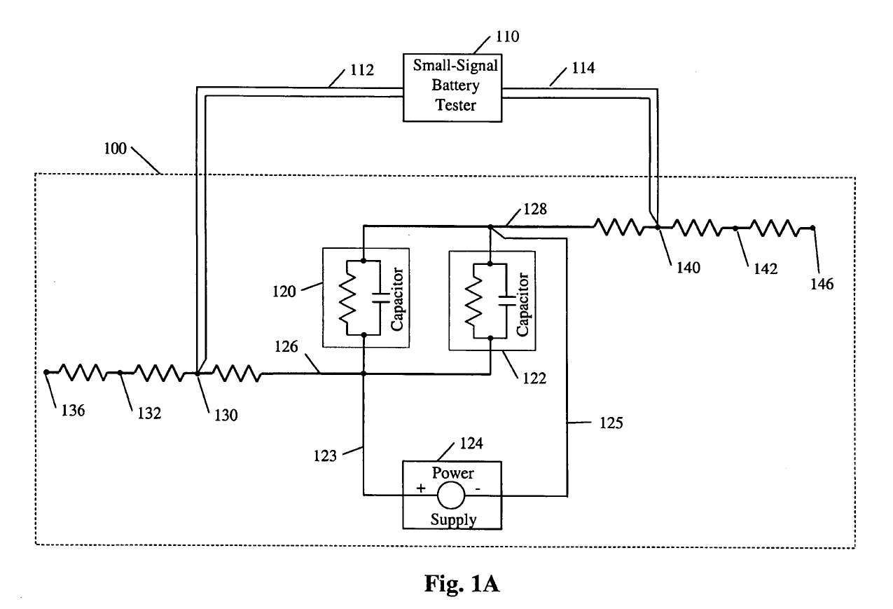

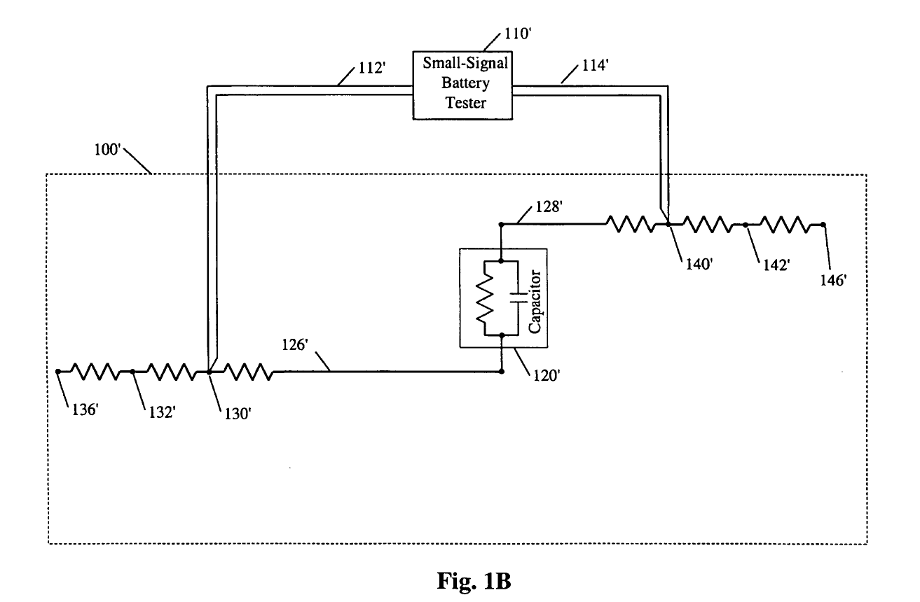

FIG. 1A illustrates a high level schematic block diagram of an exemplary embodiment of a small-signal battery tester 110 connected to a battery test circuit 100 The exemplary test circuit 100 includes a first capacitor 120 and a second capacitor 122, a power supply 124, a first conductive element 126 and a second conductive element 128.

The test and/or calibration circuit 100 is designed simulate the voltage and internal resistance, impedance, conductance or admittance of a battery. The test and/or calibration circuit 100 includes two capacitors 120, 122. The capacitors 120, 122 are connected in parallel by conductive elements 126 and 128. The conductive elements 126, 128 have a low resistance, and can be made of any conductive material such as, for example, a strip of aluminum or copper, or an aluminum or copper wire. The test circuit 100 includes a plurality of test connection points 130, 132, 136, 140, 142 and 146 for connecting the test leads 112 and 114 of a small-signal battery tester 110. The test connection points 130, 132, 136, 140, 142, and 146 can be used in pairs, such as, for example a first pair 130, 140, a second pair 132, 142, and a third pair 136, 146, having a different resistance, impedance, admittance, or conductance value between each pair. The resistance, impedance, admittance, or conductance value can be achieved by, for example, spacing the test connection points apart at a set distance. Optionally, the resistance, impedance, admittance, or conductance between each pair is set so that it is indicative of a known qualitative battery test result, such as, for example, a “good” battery, a “borderline good/bad” battery or a “bad” battery. Still yet, optionally, the value is a quantitative value that can be used to test or calibrate the small-signal battery tester 110. The number of test connector points can be reduced by, for example, having one connection point on the first conductive element 126 and a plurality of connection points on the second conductive element 128.

In addition, the test and/or calibration circuit 100 includes a power supply 124. The power supply 124 is connected across the capacitor bank 120, 122 via its cables 123, 125. The power supply 124 is connected to the terminals of capacitors 120, and 122. Optionally, the power supply is connected to the conductive elements 126, 128. The power supply 124 is a direct current (DC) power supply. The dc power supply is used to charge the capacitors 120, 122. The capacitors 120, 122 are selected and used to minimize the effect of the resistance, impedance, conductance or admittance caused by the power supply 124 on the test circuit. Optionally, the power supply 124 is a variable voltage power supply. A variable voltage power supply is adjusted to simulate various stages of charges of a battery, such as, for example, a fully charged battery, a partially charged battery or an overcharged battery.

The small-signal battery tester 110 is connected to the test and/or calibration circuit 100 at, for example, a first set of test connection points 130, 140. The small-signal battery tester 110 is activated and performs a battery test. The battery test is performed by, for example, the small-signal battery tester 110 generating a small AC signal across the test circuit 100. Since, the power supply 124 is connected in parallel with the capacitor bank 120, 122, and the capacitors have a significantly lower impedance than the power supply, the AC signal travels thru the capacitor bank rather than the power supply 124, which effectively eliminating any resistance, impedance, conductance or admittance generated by the power supply 124 from interfering with the battery tester 110 test results. The battery tester 110 measures the resistance, impedance, conductance, or admittance generated by the AC signal traveling across the test circuit. The battery tester 110 displays a test result. The test result can be compared to the known admittance, resistance, conductance or impedance of the test circuit. The comparison can be used to determine if the small-signal battery tester 110 is functioning properly or it can be used to calibrate the battery tester 110.

FIG. 1B illustrates a high level schematic block diagram of another exemplary embodiment of a small-signal battery tester 110′ connected to a battery test and/or calibration circuit 100′. The battery tester test circuit 100′ is similar to battery tester test and/or calibration circuit 100 illustrated above. The similar components are indicated with a suffix “′”. The primary difference between test and/or calibration circuit 100 and test and/or calibration circuit 100′ is that the embodiment illustrated in FIG. 1B, includes a single capacitor 120′ and does not need to include a power supply. The single capacitor 120′ is used to store a voltage and combined with the conductive strips 126′ and 128′, serves to simulate internal characteristics of a battery. A power supply, not shown, is used to charge the capacitor 120′ up to a desired voltage to simulate a charged battery and removed from the test circuit prior to testing the battery tester. Just as above, the test circuit 100′ includes a plurality of test connection points 130′, 132′, 136′, 140′, 142′, 146′ similar to that described above.

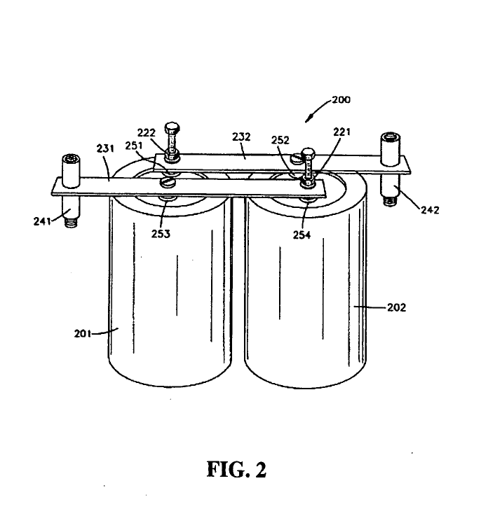

FIG. 2 illustrates an exemplary embodiment of a test and/or calibration circuit 200 for testing and/or calibrating a small-signal battery tester. The test circuit 200 includes two capacitors 201, 202 that are provided for storing an electrical charge and two conductive elements 231, 232. The conductive elements 231, 232 are connected across the terminals 251, 252, 253 and 254 of the two capacitors, connecting the capacitors in parallel. The stored charge in the capacitors and the resistance, impedance, admittance, or conductance of the conductive elements 231, 232 simulate internal characteristics of an electrical storage battery. The test circuit 200 includes two test connection points 241 and 242 for connecting a small-signal battery tester. The test connection points 240, 241 are spaced apart at distance that is a function of the resistance, impedance, admittance, or conductance of the conductive elements 231, 232 and the desired test result. The desired test result can be a qualitative result, such as, “good” battery or “bad” battery, or a quantitative value that can be compared to a battery test result. The test circuit 200 includes a pair of power supply connections 221 and 222 for connecting a power supply (not shown) to the test circuit 200 to charge the capacitors to a desired voltage. Optionally, the power supply is connected directly to the conductive elements, 231, 232.

While the present invention contemplates the use of any size of capacitor, preferably the capacitors having a capacitance significantly larger than the effective capacitance of the power supply. For example, an exemplary embodiment utilizes a pair of 100,000 microfarad capacitors. Having capacitors with a significantly larger capacitance then the effective capacitance of the power supply, allows the power supply to remain connected to the test circuit 200 during the testing process without substantially altering the characteristics of the test circuit 200. Optionally, the power supply is removed from the test circuit prior to testing the battery tester.

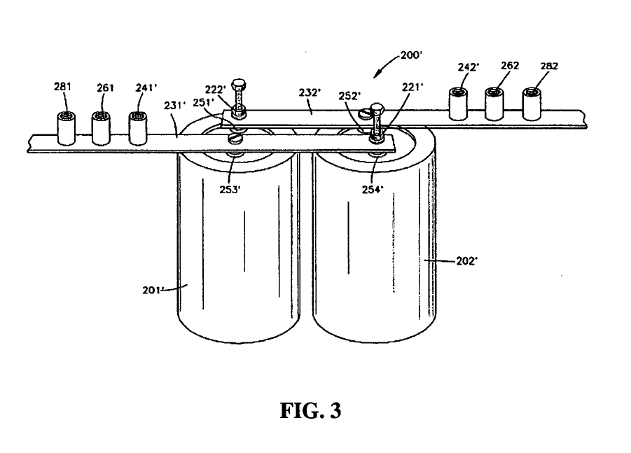

The embodiment illustrated in FIG. 3 is similar to the embodiment of FIG. 2, and the similar components are illustrated as having a “′” suffix. The primary difference is the additional test connection points. As shown in FIG. 3 the conductive elements 231′, 232′ include a plurality of test connection points, 241′242′ 261, 262, 281, and 282. Again these test connection points can be used to simulate batteries having different conductance, resistance, admittance or impedance values, and the values can be used to test and/or calibrate a battery tester.

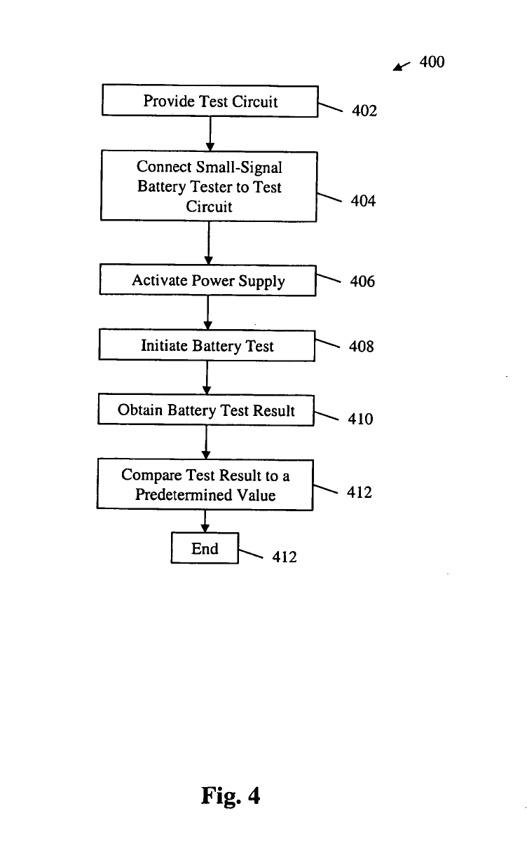

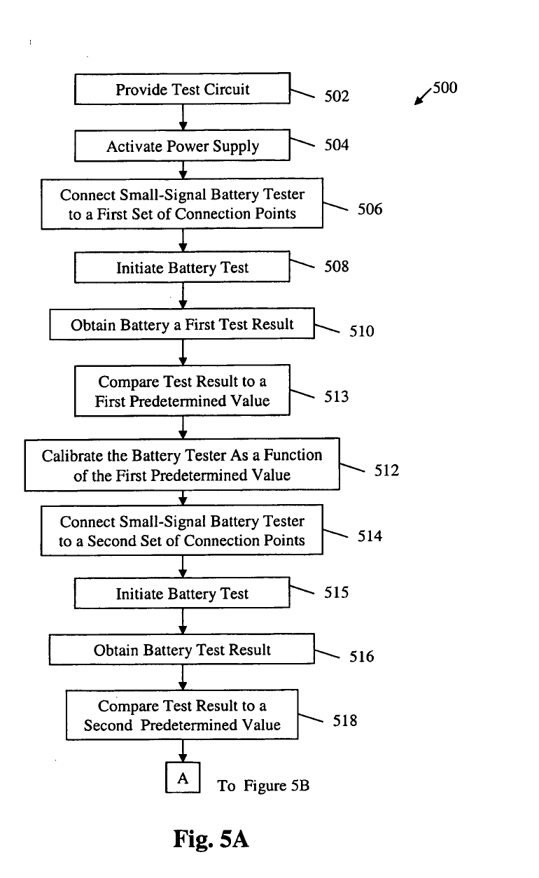

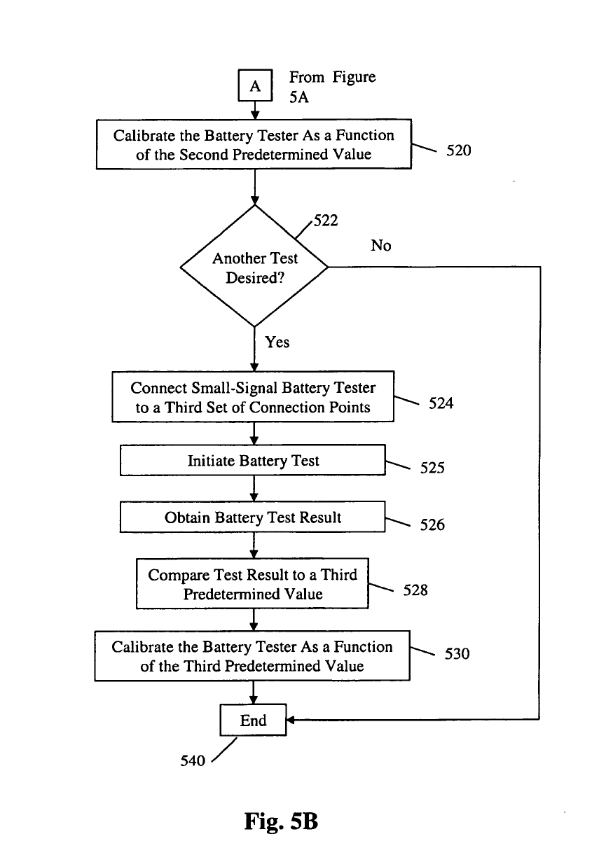

FIGS. 4, 5A and 5B illustrate exemplary methodologies for novel aspects of testing and/or calibrating a small-signal battery testing device. The blocks shown represent functions, actions or events performed therein. The functions, actions, or events may be automated or performed manually, or any combination thereof. If embodied in software, each block may represent a module, segment or portion of code that comprises one or more executable instructions to implement the specified logical function(s). If embodied in hardware, each block may represent one or more circuits or other electronic devices to implement the specified logical function(s). It will be appreciated that computer software applications involve dynamic and flexible processes such that the functions, actions or events preformed by the software and/or the hardware can be performed in other sequences different than the one shown.

FIG. 4 illustrates an exemplary methodology of testing and/or calibrating a small-signal battery tester. A test and/or calibration circuit is provided at block 402, the test circuit includes one or more capacitors, one or more conductive elements, a power supply, and at least two test connection points having a predetermined parameter, or known value, such as, for example, resistance, conductance, admittance, or inductance value between the two test connection points. A small-signal battery tester is connected to the at least two test connection points at block 404. The power supply is activated at block 406. The power supply charges the one or more capacitors to a selected voltage. The output or the power supply can be set to simulate, for example, a fully charged battery or a partially charged battery. At block 408 a battery test is initiated by the small-signal battery tester and a test result is obtained at block 410. The test result is compared to the predetermined value to determine if the battery tester is working properly. The predetermined value can be quantitative, such as, a specific resistance, impedance, conductance or admittance value or qualitative, such as, for example a “good” battery result. The comparison can be used to determine if the battery tested is functioning properly.

FIGS. 5A and 5B illustrate another exemplary methodology of testing and/or calibrating a small-signal battery tester 500. The methodology 500 begins at block 502 wherein a test circuit is provided. The test circuit includes at least one capacitor, at least one conductive element, a plurality of test connection points, and a power supply. The power supply is turned on to charge the capacitors at block 504. The small-signal battery tester is connected to a first set of connection points at block 506 and a battery test is initiated at block 508. The battery test is initiated by, for example, pressing the battery test function key on the battery tester. At block 510 the result of the battery test is obtained and preferably displayed on the small-signal battery tester. Optionally, the battery test result is communicated to a remote computer or printer. At block 512, the test result is compared to a first predetermined value. The first predetermined value can be a qualitative value, such as, for example, “good” battery, or quantitative value, such as for example, the resistance, conductance, admittance, or impedance of a good battery. At block 513 the small-signal battery tester is calibrated, if required, as a function of the test result and the predetermined value, for example, if the test result indicated a 0.0016 ohm resistance and the predetermined value was 0.0015 ohms, a calibration factor can be used to adjust the battery tester to correct the error.

At block 514 the small signal battery tester is connected to a second set of connection points and another battery test is initiated at block 515. A second test result is obtained at block 516 and compared to a second predetermined value at block 518. The second predetermined value can be a qualitative value, such as, for example, “bad” battery or a quantitative value, such as, for example, the impedance of a bad battery. At block 520 the battery tester is calibrated if required. At block 522 a decision is made as to whether another test is desired. If no additional tests are desired, the methodology ends at block 540. However, if an additional test is desired the methodology proceeds to block 524 where the small-signal battery tester is connected to a third set of connection points. A battery test is initiated at block 525 and a third test result is obtained at block 526. The third test result is compared to third predetermined value at block 528. The third predetermined value can be a qualitative or quantitative value and indicative of, for example, a “border line” battery test result, or a quantitative value indicative of the conductance of a border line battery test result. The small-signal battery tester is calibrated, if required, at block 530 and the methodology ends at block 540. Obviously this methodology works equally well for simply testing the battery testers without calibrating those testers.

While the present invention has been illustrated by the description of embodiments thereof, and while the embodiments have been described in some detail, it is not the intention of the applicant to restrict or in any way limit the scope of the appended claims to such detail. Additional advantages and modifications will readily appear to those skilled in the art, for example, the power supply can be adjusted to simulate a partially charged battery while performing battery tests. Therefore, the invention in its broader aspects is not limited to the specific details, representative apparatus and methods, and illustrative examples shown and described. Accordingly, departures may be made from such details without departing from the spirit or scope of the applicant's general inventive concept.

What is claimed is:

1. A method for testing a small-signal electronic battery tester comprising:
(a) providing a test circuit having:
(i) two or more capacitors;
(ii) at least two conductive elements for connecting the two or more capacitors in parallel;
(iii) a power supply for charging the two or more capacitors; and
(iv) a first set of test connection points having a first predetermined value between the first test connection points;
(b) connecting the small-signal electronic battery tester to the first set of test connection points;
(c) charging the capacitors;
(d) operating the small-signal battery tester to obtain a first test result; and
(e) comparing the first test result to the first predetermined value.

2. The method of claim 1 wherein the predetermined value is one of a resistance, impedance, admittance or conductance.

3. The method of claim 1 further comprising adjusting the voltage of the power supply to simulate a partially charged battery voltage.

4. The method of claim 1 further comprising calibrating the small-signal battery tester as a function of the first predetermined value.

5. The method of claim 1 wherein the predetermined value is a value is for a “good” battery.

6. The method of claim 1 wherein the predetermined value is a value is for a “good but recharge” battery.

7. The method of claim 1 wherein the predetermined value is a value is for a “bad” battery.

8. The method of claim 1 further comprising:
(a) connecting the small-signal electronic battery tester to a second set of connection points having a second predetermined value between the second set of test connection points; and
(b) operating the small-signal battery tester to obtain a second test result.

9. The method of claim 8 further comprising comparing the second test result to the second predetermined value.

10. The method of claim 9 further comprising calibrating the small-signal battery tester as a function of the second predetermined value and the second test result.

11. The method of claim 8 further comprising:
(a) connecting the small-signal electronic battery tester to a third set or connection points having a third predetermined value between the third set of test connection points; and
(b) operating the small-signal battery tester to obtain a third test result.

12. The method of claim 10 further comprising comparing the third test result to the third predetermined value.

13. The method of claim 11 further comprising calibrating the small-signal battery tester as a function of the third predetermined value and the third test result.

14. A small-signal battery tester testing and/or calibrating apparatus comprising:
(a) a first capacitor having a first terminal and a second terminal;
(b) a first conductive element connected the first capacitor;
(c) at least two connection points having one of a predetermined value between the at least two connection points; wherein the connection points are on opposite sides of the capacitor; and
(d) a power supply electrically connectable between the first and second terminals of the first capacitor.

15. The small-signal battery tester testing and/or calibrating apparatus of claim 14 wherein predetermined value comprises one of a resistance, impedance, admittance or conductance.

16. The small-signal battery tester testing and/or calibrating apparatus of claim 14 wherein the power supply is a variable power supply.

17. The small-signal battery tester testing and/or calibrating apparatus of claim 14 further comprising:
(a) a second capacitor having a first terminal and a second terminal; and
(b) a second conductive element,
wherein the first conductive element and the second conductive element are electrically connected to the first and second capacitors to place the first and second capacitors in a parallel connection.

18. The small-signal battery tester testing and/or calibrating apparatus of claim 17 comprising a plurality of connection points having a plurality of predetermined values between the connection points being.

19. The small-signal battery tester testing and/or calibrating apparatus of claim 14 wherein the power supply is connected to the test circuit.

20. The small-signal battery tester testing and/or calibrating apparatus of claim 14 wherein the power supply is removed to the test circuit.

21. The small-signal battery tester testing and/or calibrating apparatus of claim 14 wherein the predetermined value simulates a “good” battery.

22. The small-signal battery tester testing and/or calibrating apparatus of claim 14 wherein the predetermined value simulates a “bad” battery.

23. The small-signal battery tester testing and/or calibrating apparatus of claim 14 wherein the predetermined value is a calibration value for the small-signal battery tester.

24. A method for evaluating a small-signal electronic battery tester comprising:
charging a capacitance with an associated known parameter between nodes;
producing a test value by operation of a small-signal electronic battery tester between the nodes;
determining whether the small-signal electronic battery tester is in calibration as a function of the test value and the known parameter between the nodes; and
calibrating the small-signal electronic battery tester if it is not in calibration.

25. The method of claim 24 wherein the known parameter is one of a predetermined resistance, conductance, admittance or impedance.

26. The method of claim 24 further comprising producing a test result by operation of the small-signal electronic battery tester on an electrical storage battery.

27. The method of claim 24 wherein the known parameter is a calibration value.
